(19) United States
(12) Patent Application Publication
(10) Pub. No.: US 2008/0257172 A1
(43) Pub. Date: Oct. 23, 2008

(54) Control Cabinets for Food Processing Systems

(76) Inventors: Terry J. Duckworth, Wichita, KS (US); S. Duane Latham, Heath, TX (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/067,214

(22) PCT Filed: Sep. 20, 2006
(86) PCT No.: PCT/US06/36408

§ 371 Date: Mar. 18, 2008

Related U.S. Application Data
(60) Provisional application No. 60/719,252, filed on Sep. 21, 2005.

(51) Int. Cl. A47J 37/01; A47B 96/00

(52) U.S. Cl. 99/443 R; 312/236; 312/223.1

(57) ABSTRACT

A removable control cabinet for a food processing system is provided, which houses control components for a operating the system. The control cabinet can be adapted for use with any food processing system known in the art. In preferred embodiments, the cabinet is adapted for use with conveyor systems. In particularly preferred embodiments, the cabinet is adapted for use with conveyors ovens, and in particular for use with pizza ovens.

### FIELD OF THE INVENTION

The invention relates to cabinets for food processing systems. More specifically, this invention relates to control cabinets which house control components for food processing systems.

### BACKGROUND OF THE INVENTION

Food processing systems are known in the art. For example, there are many conveyor ovens used in the food industry for cooking, browning, or heating foodstuffs. Conveyor ovens come in several types and include, but are not limited to, infrared ovens, natural-convection ovens, forced-convection ovens, impingement ovens, and quartz ovens. Infrared-ovens cook at high heats by means of a highly concentrated heat source. Quartz ovens cook using high-intensity light. Natural-convention ovens cook using the natural movement of heated air and forced-convention ovens include a fan which blow the heated air throughout the oven. Impingement ovens direct the forced air onto the product. Conveyor ovens also use a variety of different fuel sources. For example, the oven can be powered by gas, electricity, wood, coal or infrared energy.

Food processing systems, regardless of the type, typically include control components which are used to drive and power the system. These control components are housed inside of the system itself, for example inside the cavity of the system. Often times, these components are placed deep within the cavity so they will not get in the way of the food processing. Should any of the components need to be repaired or replaced, the entire system must be shut down so that one can access the components inside of the system. This makes repairs to the system cumbersome and time-consuming and the process downtime results in a decrease in productivity. Also, the control components can also become dirty and may need periodic cleaning. It is often difficult to access the components inside of the system cavity, so the components cannot be easily cleaned. Dirty control components can present several problems. For example, with ovens, fire hazards can be created and unwanted flavors from old, burnt food residue can affect the food being cooked. Also, if the components are not cleaned often, the build up of dirt can cause mechanical failure or premature wear on the components. Accordingly, there is a need for a food processing system, in particular a conveyor oven, which is easy to repair, easy to clean, portable, and easy to maintain.

### SUMMARY OF THE INVENTION

A control cabinet for a food processing system is provided. In certain embodiments, the cabinet comprises control components that operate the food processing system, the control components including a burner and/or a motor, wherein the control components are housed within an interior of the cabinet, wherein the cabinet is configured to be removably mounted to an exterior of the food processing system. The control components can be all of the components needed to operate the food processing system. In some cases, the control cabinet comprises one or more walls and at least one of the one or more walls is configured to be removably mounted to the exterior of the food processing system. The wall configured to be removably mounted to the exterior of the food processing system can include one or more access openings. The burner or a thermocouple can be positioned partially through one of the access openings. In some cases, the cabinet comprises a front wall that is configured as a hinged door. Likewise, in some cases, the cabinet comprises a top wall that is configured as a removable lid. The cabinet can further include a control panel that controls the control components. An electrical component board can be provided that is removably mounted to an interior of the control cabinet. Also, one or more quick disconnect connectors can be provided, which are coupled to the control components and are configured to be connected to an external energy source.

In some embodiments, the control cabinet comprises two side walls, a front wall configured as a hinged door, a rear wall configured to be removably mounted to an exterior of the food processing system, the rear wall including one or more access openings corresponding to access openings on the food processing system, and a top wall and a bottom wall, the top wall configured as a removable lid, wherein the control cabinet houses control components that operate the food processing system. The control cabinet can further include an electrical component board removably mounted to an interior of the control cabinet, the component board configured to hold one or more control components. In some cases, the electrical component board is removably mounted to an interior of one of the side walls. For example, two mounting brackets can be mounted on an interior of one of the side walls, so the component board is configured to slide in and out between the mounting brackets and side wall interior. In some cases, the electrical component board is configured to slide out between the mounting brackets and side wall interior and be held in a raised position above the control cabinet.

A food processing system is also provided. The system includes control components that operate the food processing system, the control components including a burner and/or a motor, and a control cabinet which houses the control components, wherein the control cabinet is removably mounted to an exterior of the food processing system. The control cabinet can include one or more access openings which correspond to access openings on the food processing system. A burner is positioned through one of the access openings, so that the burner is positioned in both the control cabinet and food processing system. Likewise, a thermocouple can be positioned through one of the access openings, so that the thermocouple is positioned in both the control cabinet and food processing system. In some cases, the control cabinet comprises a front wall that is configured as a hinged door or a top wall that is configured as a removable lid. The control cabinet can further include a control panel for controlling the control components or one or more quick disconnect connectors which are coupled to the control components and are adapted to be connected to an external energy source. In certain cases, the food processing system includes two or more conveyor ovens, wherein a control cabinet is removable mounted to an exterior of each conveyor oven, each control cabinet housing control components.

### BRIEF DESCRIPTION OF THE DRAWINGS

FIG. 1 illustrates a perspective view of a conveyor system and control cabinet according to an embodiment of the invention;

FIG. 2 illustrates a perspective view of a conveyor system and control cabinet according to an embodiment of the invention wherein the control cabinet is detached from the conveyor system;

FIG. 3 illustrates a perspective view of a conveyor system and multiple control cabinets according to an embodiment of the invention;

FIG. 4 illustrates a rear perspective view of a control cabinet according to an embodiment of the invention;

FIG. 5 illustrates a front perspective view of a control cabinet according to an embodiment of the invention;

FIG. 6 illustrates a front perspective view of a control cabinet according to an embodiment of the invention;

FIG. 7 illustrates a perspective view of a bottom wall of a control cabinet according to an embodiment of the invention;

FIG. 8 illustrates a perspective view of a bottom wall of a control cabinet according to another embodiment of the invention;

FIG. 9 illustrates a perspective view of a top wall of a control cabinet according to an embodiment of the invention;

FIG. 10 illustrates a front view of a rear wall of a control cabinet according to an embodiment of the invention;

FIG. 11 illustrates a front view of a front panel of a control cabinet according to an embodiment of the invention;

FIG. 12 illustrates a front view of a front wall of a control cabinet according to an embodiment of the invention;

FIG. 13 illustrates a front view of a side wall of a control cabinet according to an embodiment of the invention;

FIG. 14 illustrates a front view of another side wall of a control cabinet according to an embodiment of the invention;

FIG. 15 illustrates a front view of an opening cover of a control cabinet according to an embodiment of the invention;

FIG. 16 illustrates a perspective view of an electrical component board of a control cabinet according to an embodiment of the invention;

FIG. 17 illustrates a perspective view of an electrical component board of a control cabinet according to another embodiment of the invention;

FIG. 18 illustrates a perspective view of a retaining bracket for an electrical component board according to an embodiment of the invention;

FIG. 19 illustrates a perspective view of another retaining bracket according to an embodiment of the invention;

FIG. 20 illustrates a top view of the internal cavity of a control cabinet according to an embodiment of the invention;

FIG. 21 illustrates a front side view of the internal cavity and internal rear wall of a control cabinet according to an embodiment of the invention;

FIG. 22 illustrates a perspective view of the internal cavity of a control cabinet according to an embodiment of the invention;

FIG. 23 illustrates a side view of the internal cavity and electrical component board of a control cabinet according to an embodiment of the invention;

FIG. 24 illustrates a top perspective view of the internal components of a control cabinet according to an embodiment of the invention;

FIG. 25 illustrates a top perspective view of the internal components of a control cabinet according to another embodiment of the invention; and

FIG. 26 illustrates a side view of a conveyor system and control cabinet according to an embodiment of the invention wherein the control cabinet is connected to external power and gas sources.

### DETAILED DESCRIPTION OF THE PREFERRED EMBODIMENTS

The following detailed description is to be read with reference to the drawings, in which like elements in different drawings have like reference numbers. The drawings, which are not necessarily to scale, depict selected embodiments and are not intended to limit the scope of the invention. Skilled artisans will recognize that the given examples have many alternatives that fall within the scope of the invention.

A control cabinet for a food processing system is provided, which houses control components for operating the system. The control cabinet can be adapted for use with any food processing system known in the art. In preferred embodiments, the cabinet is adapted for use with conveyor systems. In particularly preferred embodiments, the cabinet is adapted for use with conveyor ovens, and in particular for use with pizza ovens.

The control cabinet, including the control components housed within the cabinet, can be easily removed from the system and replaced should any of the components need to be replaced, repaired or cleaned. The cabinet can be sent to a repair person to repair or replace the malfunctioning component. Likewise, should any of the components become dirty, the cabinet can be removed to clean the dirty components. Since the components are located within an easily removable cabinet, the components are easy to access and clean. Also, since the control components are housed within the cabinet and are not in proximity to the food inside the food processing system, less or substantially no food residue will build up on the components, thereby causing mechanical failure or premature wear to the components. Also, the control cabinet can be temporarily replaced with a spare or replacement cabinet so that the system can continue production while repairs are being made or cleaning is performed. In addition, the control components inside the cabinet are easily accessible.

The cabinet can be of any suitable size and shape necessary to house control components to operate the food processing system. The cabinet generally includes an interior cavity defined by top, bottom, front, rear and side walls. The control cabinet is preferably mounted to a portion of the food processing system so that the cabinet can be easily accessed and removed. In certain embodiments, the food processing system also has an interior cavity defined by top, bottom, front, rear and side walls, and the control cabinet is secured to the food processing system so that it is outside of the cavity. For example, the cabinet can be mounted to an exterior side of one of the top, bottom, front, rear and side walls of the system. Thus, the control cabinet can be located on the top, bottom, front, rear or side of the system. The control cabinet can be removably mounted to the system, so that it can easily be removed. One of skill in the art can removably mount the control cabinet to the system using any removable mounting procedures known in the art.

In preferred embodiments, a rear wall of the cabinet is mounted to the system. Of course, any of the cabinet walls can be mounted to any of the walls of the system. The cabinet can be mounted using any conventional method known in the art and is preferably mounted using a mechanism where the cabinet can be quickly and easily mounted and then dismounted. For example, the cabinet can be attached using slide pins, lock pins, bolts, hooks and the like. In some cases, the cabinet is mounted using bolts which are inserted through a cabinet wall into a wall of the oven cavity. In certain cases, the cabinet wall includes openings, e.g., keyhole openings, which allow a head of a bolt to pass through the wall in the lower part of the opening but not in the upper part. The bolts are inserted partially into a wall of the cavity and then the cabinet wall is lowered onto the bolts so that the bolt heads are positioned in the upper part of the openings. The cabinet can simply hang on the bolt heads (like a picture frame hangs on a nail in a wall). The bolts can then optionally be tightened to firmly secure the cabinet wall to the wall of the cavity.

In some embodiments, the control cabinet includes substantially all of the components needed to operate or power the system. In cases where the system is a conveyor oven, the control cabinet, in some embodiments, includes but is not limited to, burners, valves, electrical components, fuses, switches, cabinet fans and drive motors. The switches may include on/off switches for the oven, oven fan, cabinet fan and conveyor belt. Likewise, the conveyor belt and drive motors may control the conveyor belt speed. In certain embodiments, a control cabinet for a conveyor oven is provided which includes all oven components except for oven fans, which are positioned inside of the oven cavity. In certain embodiments, the control cabinet may contain simple control switches, and in other embodiments, the control cabinet can include sophisticated electronics such as programmable touch screens.

The control cabinet is also preferably secured to the food processing system so that the control components have access to the internal cavity. For example, in many cases, a rear wall of the cabinet is mounted to one of the walls forming the internal cavity and both of these adjacent walls include one or more openings which extend through the cabinet into the interior cavity. The openings allow control components in the cabinet to access the interior cavity of the system and thereby provide their desired function. For example, a gas burner within the cabinet can extend through a gas burner opening into the interior cavity to provide heating to the system cavity. Also, a thermocouple can extend through a thermocouple opening into the interior cavity to sense heat within the cavity.

The control cabinet may also include one or more openings to allow the internal components to be coupled to power, gas or other sources exterior of both the cabinet and the food processing system. In most cases, the cabinet includes connectors within one or more cavity walls for connecting power, gas and other sources to the components. The connectors are preferably quick connect receptacles which are coupled to the components. When an external source (e.g., a power or gas source) is connected to or plugged into that receptacle, the component can be operated. The connectors can be provided in any of the cabinet walls and, in many cases, are provided about a side wall.

The invention also provides a food processing system having one or more control cabinets mounted thereon. In some cases the food processing system includes one or more conveyor ovens and also one or more control cabinets for operating the conveyor ovens.

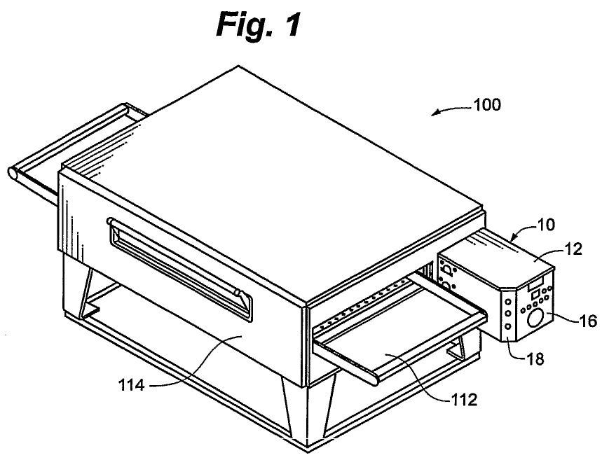

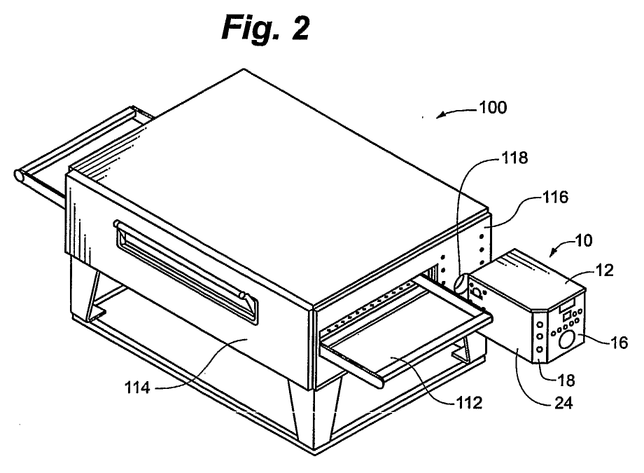

A particularly preferred embodiment of the invention will now be described. FIG. 1 depicts a conveyor system 100 in accordance with an embodiment of the invention. The conveyor system 100 includes a conveyor cavity 114 having an interior (not shown) and a conveyor belt 112. The conveyor system can be any type of conveyor known in the art, including but not limited to conveyor ovens. In preferred embodiments, the conveyor system 100 is a pizza oven. A cabinet 10 is provided, which is attached, preferably removably attached, to an external part of the conveyor system 100. The cabinet 10 houses control components which are used to drive and power the conveyor system. FIG. 2 illustrates the conveyor system 100 wherein the cavity 10 is detached. An access hole 118 is provided about the front wall 116 of the conveyor system.

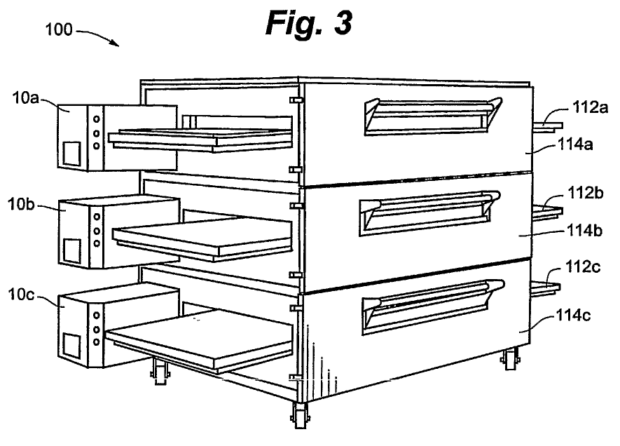

While FIGS. 1 and 2 illustrate a conveyor system 100 having a single conveyor cavity and a single cabinet 10, more than one cavity and cabinets can be provided as part of the same conveyor system. For example, as illustrated in FIG. 3, the conveyor system can include more than one cabinet and more than one conveyor oven cavity. In FIG. 3, three cabinets, 10a, 10b and 10c are provided for each of the cavities 114a, 114b and 114c. Of course, each cavity 114a, 114b and 114c have their own conveyor belts 112a, 112b and 112c.

In the illustrated embodiments, the cabinet 10 is attached to a front wall 116 of the conveyor system 100. Of course, the cabinet 10 can also be attached to either a side or a rear wall of the conveyor system. In some cases, the cabinet can be attached to a top or bottom wall of the system 100, so long as it is attached to an external portion of the system. When the cabinet is attached to a front wall, it is typically in close proximity to the conveyor belt and oven opening. In most cases, the cabinet will be positioned either to the right or to the left of the conveyor belt. In FIGS. 1 and 2, the cabinet is positioned to the right of the belt whereas in FIG. 3, the cabinets are positioned to the left of the belts.

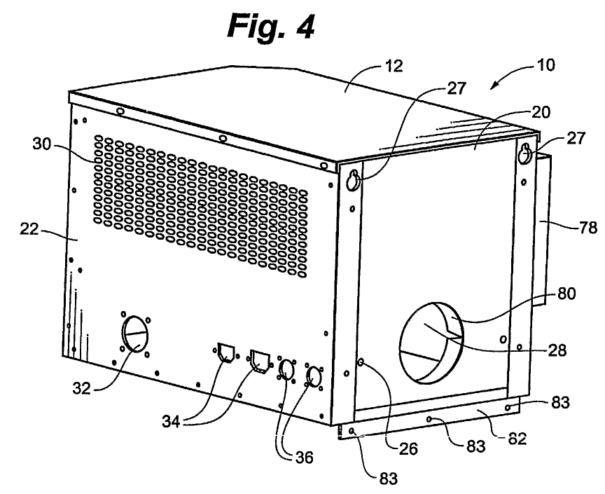

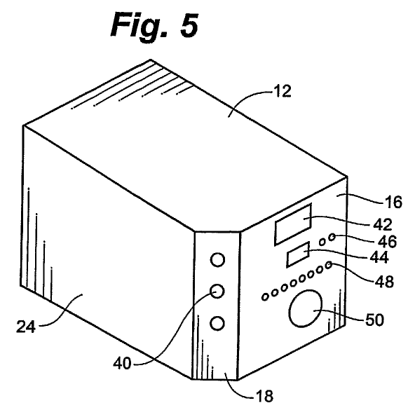

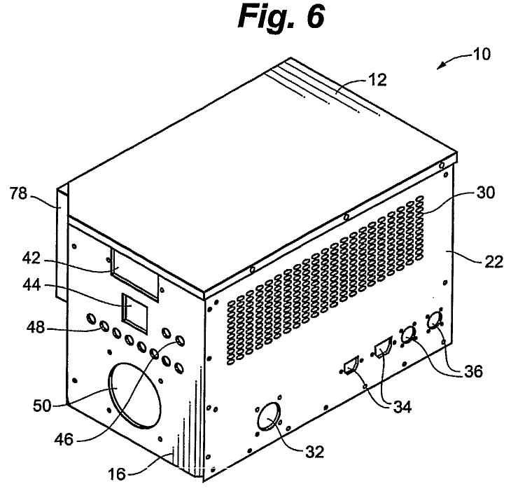

With reference to FIGS. 4-6, the cabinet 10 includes a top wall 12 and a bottom wall 14. A front wall 16, a rear wall 20 and side walls 22 and 24 are also provided. The cabinet 10 also has a hole 28 provided in its rear wall 20 which corresponds to the hole 118 which is part of the conveyor cavity (as shown in FIG. 2). When the rear wall 20 of the cabinet is mounted to the front wall of the cavity, these holes 28 and 118 are aligned to provide access from the internal cavity of the cabinet to the interior cavity of the conveyor system 100. A clamp 80 is provided inside the cabinet surrounding the hole 28. A gas burner can be inserted through the holes 28 and 118 into the interior of the conveyor cavity and is held in place by the clamp 80. The rear wall 20 of the cabinet also includes an opening 26 which corresponds to a hole (not shown) in the front wall 116 of the conveyor system. A thermocouple is adapted to be inserted through these openings into the interior of the cavity. Also, a chain guard 78 can be provided on the side wall 24 to cover drive sprockets and a drive chain of the conveyor system. A chain guard 78 is illustrated in FIGS. 4 and 6.

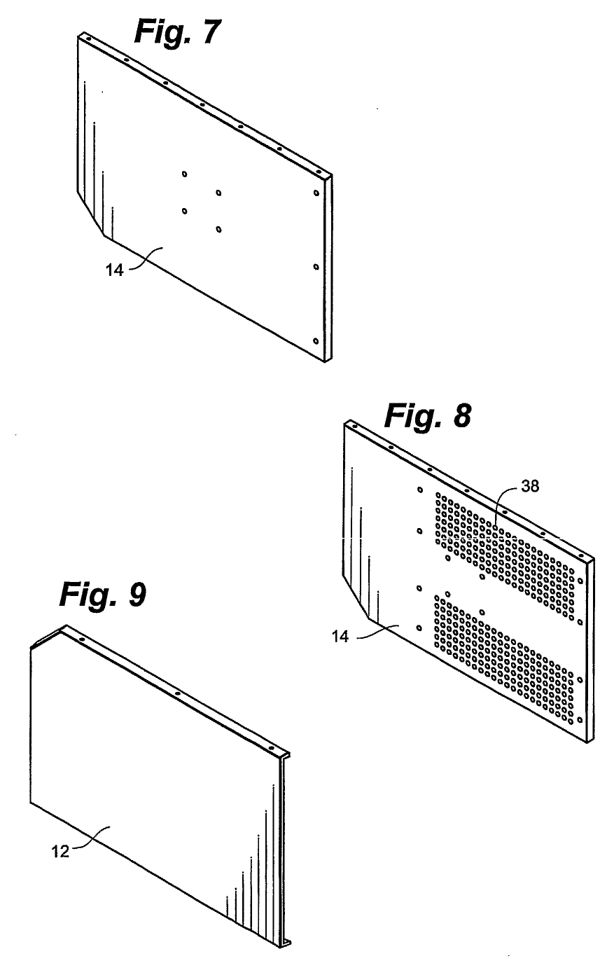

FIGS. 7 and 8 illustrate embodiments of a bottom wall 14 of the cabinet. FIG. 9 illustrates a top wall 12. In the embodiment shown in FIG. 8, the bottom wall 14 includes a vent 38 to allow air to enter or exit the cabinet. A cabinet fan may be provided inside of the cabinet to help cool the internal components, to provide air to the burner for combustion, and to direct air out of the cabinet through the vents. In the embodiment shown in FIG. 7, a vent is not provided. Vents are optional and can be placed anywhere about the control cabinet, not just the bottom wall 14. As shown in FIGS. 7-8 and 9, the top 12 and bottom 14 also each have a corner which has been removed. This corner is removed in order to create an additional face to the cabinet structure so that a control panel 18 can be installed. Of course, this is by no means required. In some cases, both the top 12 and bottom 14 are perfect rectangles and the control panel is located elsewhere about the cabinet.

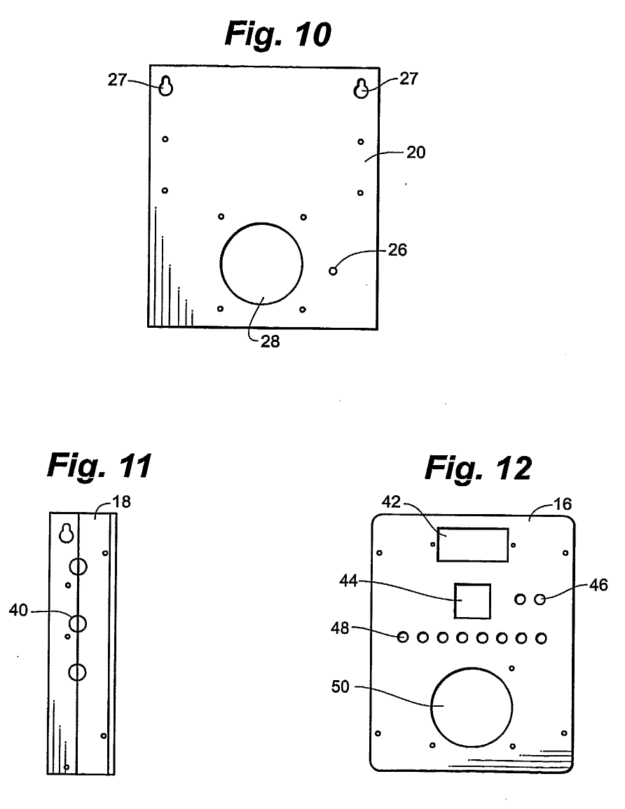

FIG. 10 illustrates a rear wall 20 of the cabinet. As already explained, the rear wall 20 includes a thermocouple hole 26 and a gas burner hole 28 which correspond to holes within the front wall 116 of the conveyor system to allow for a thermocouple and a gas burner to access the interior of the conveyor system. The rear wall 20 also includes keyholes 27 which can be placed over hooks or bolts or like structures located on the conveyor system. This allows the control cabinet to hang on the conveyor system. The control cabinet can be further secured to the conveyor system using a mounting bracket 82 (shown best in FIG. 4). Such a mounting bracket 82 is located beneath the rear wall 20 and contains mounting holes 83. Bolts or rivets can be inserted through the mounting holes 83 and into the conveyor system. The control cabinet can also be secured to the mounting bracket 82 with removable screws.

FIG. 11 illustrates a front panel 18 and FIG. 12 illustrates a front wall 16. The front panel 18 includes controls 40 which are coupled to certain components inside the control cabinet and control those components. The controls may be in the form of buttons, switches or even touchscreens. In some cases, the controls are electrically coupled to the components. The controls may also include one or more switches for controlling the components. In certain preferred embodiments, the front panel 18 includes controls for controlling any one of the conveyor belt speed, oven temperature, and on/off switches for the oven, oven fan, cabinet fan and the conveyor belt.

The front wall 16 includes one or more additional controls. In the illustrated FIG. 12, a conveyor belt controller 42 is provided for controlling the speed of the conveyor belt, a temperature controller 44 can be provided for controlling the temperature of the oven, and one or more fuses 46 and/or circuit breakers 48 are provided. A control cabinet cooling fan 50 is also positioned within the front wall 16 for directing hot air out of the cabinet through a wall 16 and/or directing cooling and combustion air into the cabinet. An on/off switch for the cabinet fan may be positioned on the fan 50 itself or on the front wall 16 and then electrically coupled to the fan 50. In certain embodiments, the front wall 16 serves as a door which can be opened and closed. A hinge (not shown) can be placed on the corner between side wall 22 and front wall 16. The hinge can be connected to front wall 16 to allow the wall to function as a door. This allows for a person to have further methods of accessing the interior of the control cabinet. A person can either remove the top wall 12 or open the front door 16 to gain access to the interior. Thus, the interior control cabinet is easier to clean and the components are easier to access.

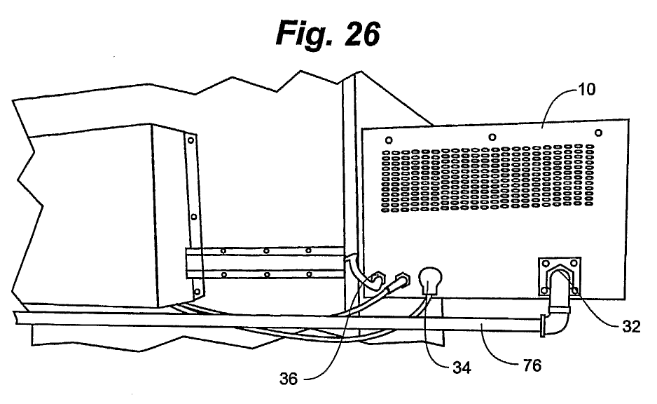

FIG. 13 illustrates a first side wall 22 including a vent 30 and connectors to allow the internal components to be coupled to power, gas or other sources exterior of the cabinet 10. The vent 30 can be omitted, if desired. In the illustrated embodiment, a gas connector 32, electrical power connectors 34 and oven electricity connectors 36 are provided. The connectors are preferably quick-disconnect connectors and are coupled to their respective components. For example, with reference to FIG. 26, electrical power cords 78 connected to an electrical source can easily be plugged into each the electrical power connectors 34 and the oven connectors 36. Likewise, the gas connector 32 is preferably a gas inlet which is adapted to be connected to a gas line 76. The gas connector 32 is also coupled to a gas burner inside the cavity.

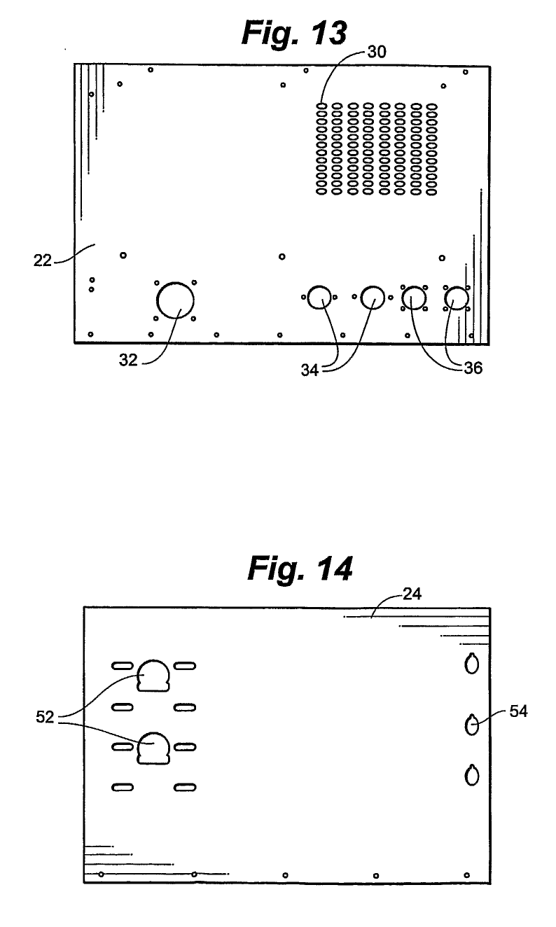

FIG. 14 illustrates a second side wall 24. The side 24 includes additional controls 54 which are coupled to certain components inside the control cabinet and control those components. Controls 54 present on the side wall 54 may or may not be different than those already present on the control panel 18. The side wall 24 also includes mounting holes 54 for mounting one or more drive motors for the conveyor belts. In some cases, bolts are inserted through the holes 54 and secure a drive motor to the side wall 24. The one or more drive motors are preferably located inside of the control cabinet. If only one drive motor is mounted to the side wall, any additional visible mounting holes 54 can be covered by a cover plate 17 as illustrated in FIG. 15. The cover plate 15 also includes one or more mounting holes 56 for mounting the cover plate 1 to the side wall 24.

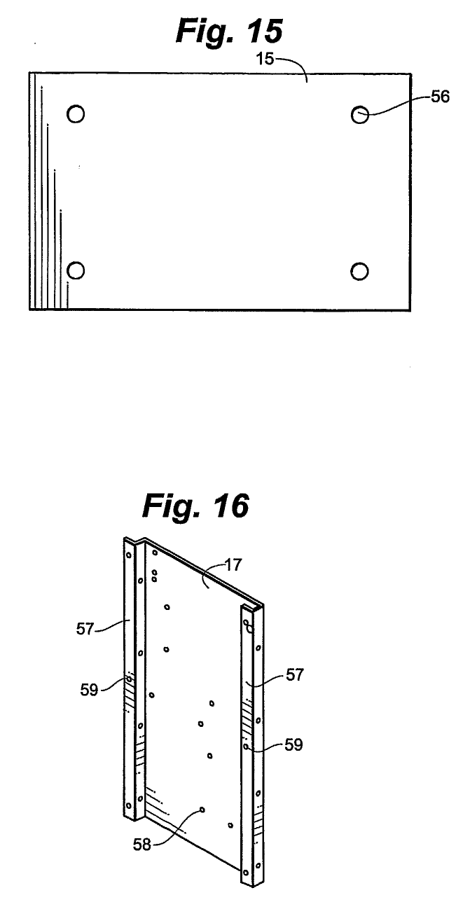

FIG. 16 illustrates an electrical component board 17 according to one embodiment. The board 17 has one or more mounts 58 for mounting electrical components thereon. In preferred cases, one or more switches, fuses and/or circuit breakers are mounted onto the board 17. The board 17 is mounted to an internal wall of the control cabinet cavity. For example, the board 17 can be mounted to an internal portion of the side wall 22. The board 17 in this embodiment has side flanges 57 which include holes 59. Bolts can be inserted through holes and into a cabinet wall.

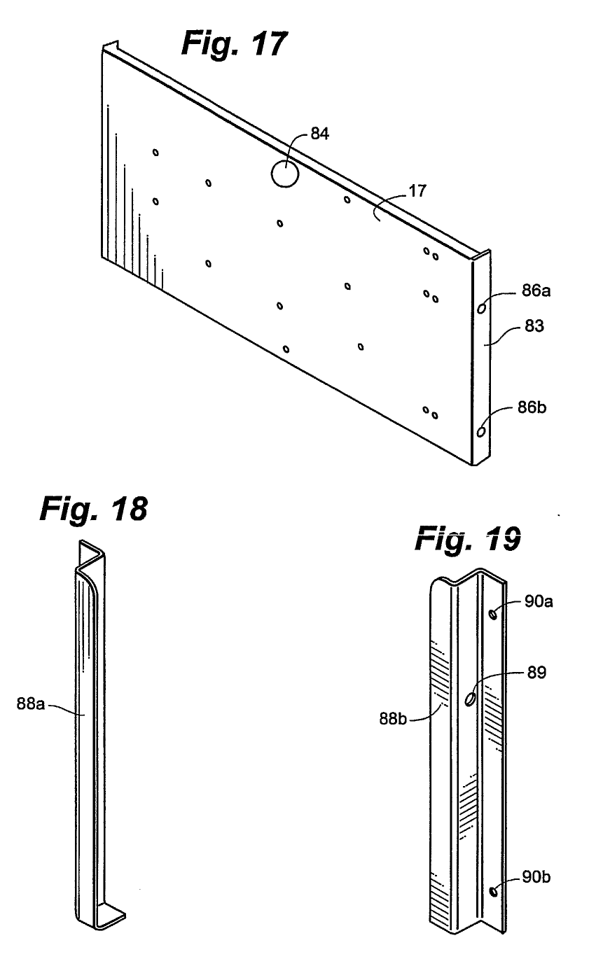

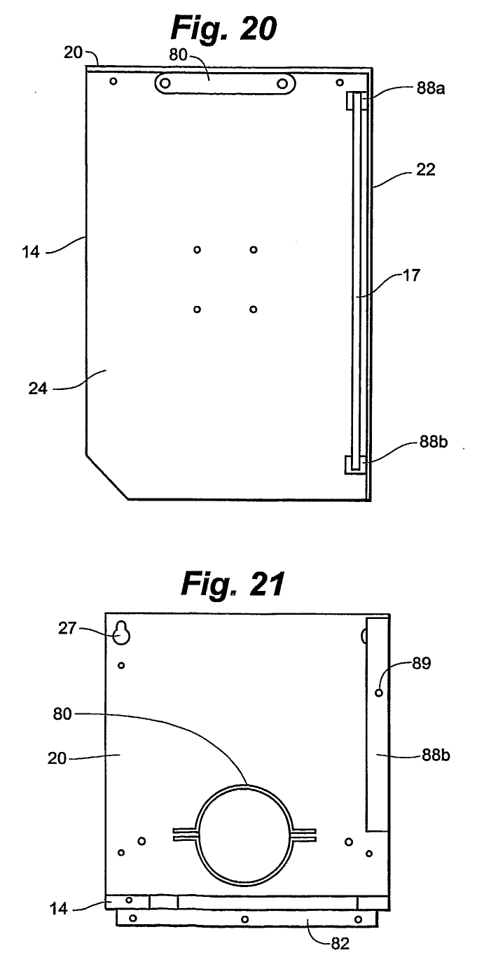

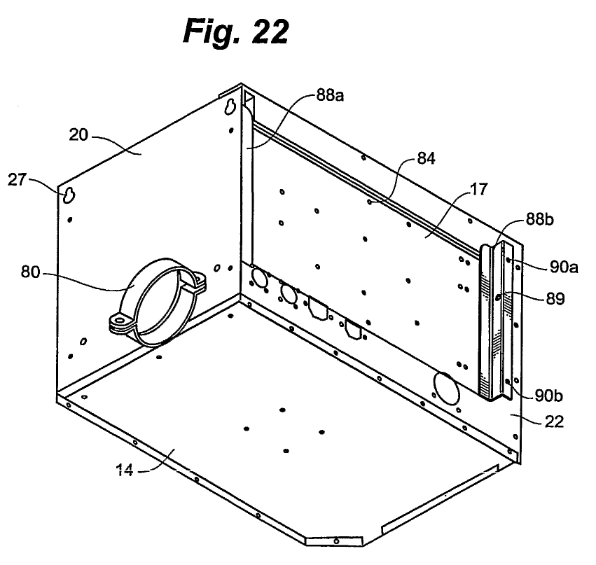

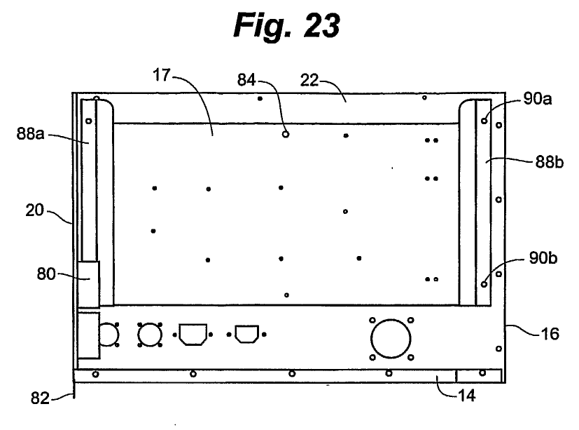

FIG. 17 illustrates an electrical component board according to another embodiment. In this embodiment, the board is removably mounted to an interior of the control cabinet. The board 17 can be removably held in place along an interior wall using brackets. FIGS. 18 and 19 illustrate brackets 88a and 88b that can be used to hold the board in place. The brackets have holes (for example holes 90a and 90b as shown win FIG. 19) for receiving bolts or rivets which are then secured to a cabinet wall. FIGS. 20-23 show the brackets 88a and 88b mounted to a side wall 22. The component board 17 is inserted in between the brackets and side wall 22 and can slide up and down. A knob 84 is also provided to allow a repair person to easily grasp the knob and slide the board up and down. A biased or spring-loaded pin can be provided in a hole 89 on one or both of the brackets 88a and 88b. The pin can be received by holes 86a and 86b provided on a side 83 of the component board 17.

When component board 17 is to be secured inside of the cabinet, a person can insert the board downward between the brackets so that the pin is received by hole 86a. In this position, the board 17 is positioned within the interior of the control cabinet and the top wall or lid 12 can be secured in place. When a repair person desires to access the component board, he or she removes the lid 12 and slides the board 17 upwardly until the pin is received by hole 86b. In this position, the board 17 is mounted in a raised position partly outside of the cabinet so that a repair person can easily access the electrical components. The pin can be manually retracted in order to raise and lower the board. Thus, the control cabinet is configured so the electrical components and component board are easy to access. This makes cleaning and repair services easier to accomplish.

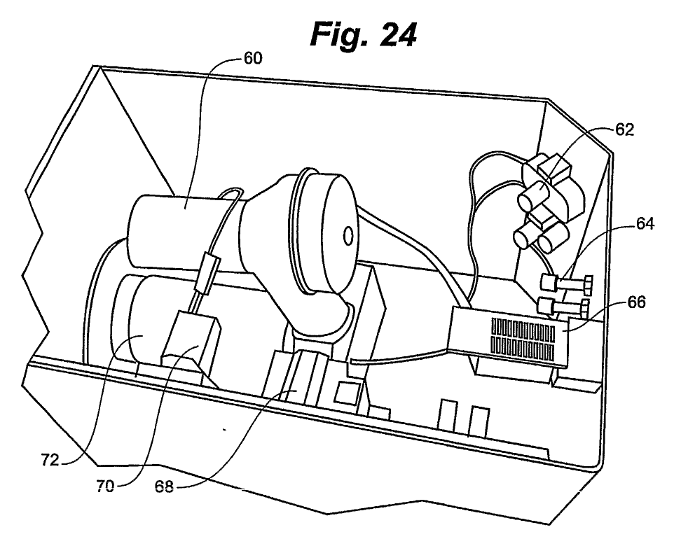

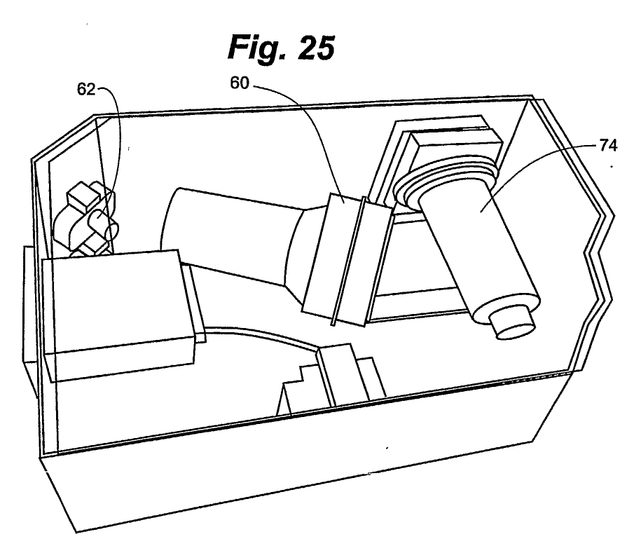

FIGS. 24 and 25 illustrate an interior view of the components inside of a control cabinet. The components include a fan 60 for supplying combustion air for the burner. A series of switches 62 are positioned on an interior portion of the front panel 18. The switches 62 are preferably electrically coupled to the controls 40 which are located on an exterior portion of the front panel 18. One or more fuses 64 and a temperature controller 66 are preferably mounted to an interior portion of the front wall 16. An oven burner 72 is preferably mounted to a rear wall 20 of the cabinet. Preferably, the oven burner 72 access the internal portion of the oven via an access hole. The cabinet also includes a motor 74 for driving the conveyor belt. Various other electrical components may be provided, such a transformer 68 and a relay 70.

What is claimed is:

1. A control cabinet for a food processing system, the cabinet comprising control components that operate the food processing system, the control components including a burner and/or a motor, wherein the control components are housed within an interior of the cabinet, wherein the cabinet is configured to be removably mounted to an exterior of the food processing system.

2. The control cabinet of claim 1 wherein the control cabinet comprises one or more walls and at least one of the one or more walls is configured to be removably mounted to the exterior of the food processing system.

3. The control cabinet of claim 1 wherein the wall configured to be removably mounted to the exterior of the food processing system includes one or more access openings.

4. The control cabinet of claim 1 wherein the control components are all of the components needed to operate the food processing system.

5. The control cabinet of claim 1 wherein the control cabinet comprises one or more walls and at least one of the one or more walls is configured to be removably mounted to the exterior of the food processing system.

6. The control cabinet of claim 1 wherein the wall configured to be removably mounted to the exterior of the food processing system includes one or more access openings.

7. The control cabinet of claim 4 wherein the burner is positioned partially through one of the access openings.

8. The control cabinet of claim 4 wherein a thermocouple is positioned partially through one of the access openings.

9. The control cabinet of claim 1 wherein the control cabinet comprises a front wall that is configured as a hinged door.

10. The control cabinet of claim 1 wherein the control cabinet comprises a top wall that is configured as a removable lid.

11. The control cabinet of claim 1 further comprising a control panel that controls the control components.

12. The control cabinet of claim 1 further comprising an electrical component board removably mounted to an interior of the control cabinet.

13. The control cabinet of claim 1 further comprising one or more quick disconnect connectors which are coupled to the control components and are configured to be connected to an external energy source.

14. A food processing system, comprising:
control components that operate the food processing system, the control components including a burner and/or a motor, and
a control cabinet which houses the control components, wherein the control cabinet is removably mounted to an exterior of the food processing system.

15. The food processing system of claim 12 wherein the control cabinet includes one or more access openings which correspond to access openings on the food processing system.

16. The food processing system of claim 13 wherein a burner is positioned through one of the access openings, so that the burner is positioned in both the control cabinet and food processing system.

17. The food processing system of claim 13 wherein a thermocouple is positioned through one of the access openings, so that the thermocouple is positioned in both the control cabinet and food processing system.

18. The food processing system of claim 12 wherein the control cabinet comprises a front wall that is configured as a hinged door.

19. The food processing system of claim 12 wherein the control cabinet comprises a top wall that is configured as a removable lid.

20. The food processing system of claim 12 wherein the food processing system is a conveyor oven.

21. The food processing system of claim 12 wherein the control cabinet further comprises a control panel for controlling the control components.

22. The food processing system of claim 12 wherein the control cabinet further comprises one or more quick disconnect connectors which are coupled to the control components and are adapted to be connected to an external energy source.

23. The food processing system of claim 12, where in the system includes two or more conveyor ovens, wherein a control cabinet is removable mounted to an exterior of each conveyor oven, each control cabinet housing control components.

24. A control cabinet for a food processing system, the cabinet comprising
two side walls;
a front wall configured as a hinged door;
a rear wall configured to be removably mounted to an exterior of the food processing system, the rear wall including one or more access openings corresponding to access openings on the food processing system; and
a top wall and a bottom wall, the top wall configured as a removable lid;
wherein the control cabinet houses control components that operate the food processing system.

25. The control cabinet of claim 20 further comprising an electrical component board removably mounted to an interior of the control cabinet, the component board configured to hold one or more control components.

26. The control cabinet of claim 21 wherein the electrical component board is removably mounted to an interior of one of the side walls.

27. The control cabinet of claim 22 wherein two mounting brackets are mounted on an interior of one of the side walls, and the component board is configured to slide in and out between the mounting brackets and side wall interior.

28. The control cabinet of claim 23 wherein the electrical component board is configured to slide out between the mounting brackets and side wall interior and be held in a raised position above the control cabinet.

29. A food processing system, comprising:
a conveyor oven; and
a control cabinet housing control components that operate the conveyor oven, the control cabinet having a wall configured to be removably mounted to an exterior of the conveyor oven, the wall including one or more access openings that correspond to access openings on the exterior of the conveyor oven;
wherein at least one of the control components is inserted through each of the access openings, so that the control component is positioned inside both the cabinet and the conveyor oven.
